(19) United States
(12) Patent Application Publication
(10) Pub. No.: US 2016/0371717 A1
(43) Pub. Date: Dec. 22, 2016

(54) Systems, Devices, and/or Methods for Managing Automated Payments

(71) Applicant: Benjamin C Black, Charlottesville, VA (US)

(72) Inventor: Benjamin C Black, Charlottesville, VA (US)

(21) Appl. No.: 14/745,263

(22) Filed: Jun. 19, 2015

(51) Int. Cl. G06Q 30/02

(52) U.S. Cl. CPC G06Q 30/0233

(57) ABSTRACT

Certain exemplary embodiments can provide a method comprising, via a signal from an information device, causing a charge to a financial account of a plurality of financial accounts. The financial account can be automatically selected for the charge based upon a determination that a reward for using the financial account for the charge is more valuable than any other determined reward for using any other of the plurality of financial accounts.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is a block diagram of an exemplary embodiment of a system 1000;

FIG. 2 is a flowchart of an exemplary embodiment of a method 2000; and

FIG. 3 is a block diagram of an exemplary embodiment of an information device 3000.

### DETAILED DESCRIPTION

Certain exemplary embodiments can provide a method comprising, via a signal from an information device, causing a charge to a financial account of a plurality of financial accounts. The financial account can be automatically selected for the charge based upon a determination that a reward for using the financial account for the charge is more valuable than any other determined reward for using any other of the plurality of financial accounts.

Certain exemplary embodiments provide systems, devices, and/or methods for managing automated payments via information devices. Consumers can have a plurality of financial accounts such as, for example, credit card accounts, debit card accounts, lines of credit, and/or savings accounts, etc. A plurality of the financial accounts of the consumer can comprise rewards programs that allow the consumer to accumulate rewards points, miles, and/or money based upon frequency of use and/or the dollar value of use of the financial accounts. In addition, some financial accounts provide different levels or rewards depending upon the nature of the purchase (e.g., some financial accounts provide a different level of rewards for airline tickets, fuel purchases, dining purchases, and/or other categories). Because accounts can have different rewards characteristics, the consumer can have a difficult time determining which financial account to use in order to obtain the highest desired reward valuation for a given transaction.

Providers of information devices and/or applications for information devices are now providing platforms in which financial account information can be used. For example, Apple® (Apple is a registered trademark of Apple Inc., a California corporation having an address of 1 Infinite Loop Cupertino Calif. 95014) now provides a function called “Apple Pay™” (Apple Pay is a trademark for which registration is currently pending of Apple Inc.) on certain exemplary information devices. Other examples can be analogous applications for information devices using the Android operating system and/or any other platform wherein a selection can be made for a purchase from a plurality of financial accounts. In certain exemplary embodiments, a provider of services (e.g., Apple Pay™) can charge a fee for selecting an account with a most valuable reward (e.g., 20% of the reward and/or a premium amount of the reward for the selected account). In certain exemplary embodiments, the value of the reward for the selected account can be called a value added credit (“VAC”).

Certain exemplary embodiments provide a method to determine a rewards program providing a highest valued reward for a given transaction. The information device can be constructed to automatically communicate with a server. The server can be constructed to communicate with each of the plurality of financial account providers and to request and receive information concerning the characteristics of each rewards program. The information device can receive information from the server.

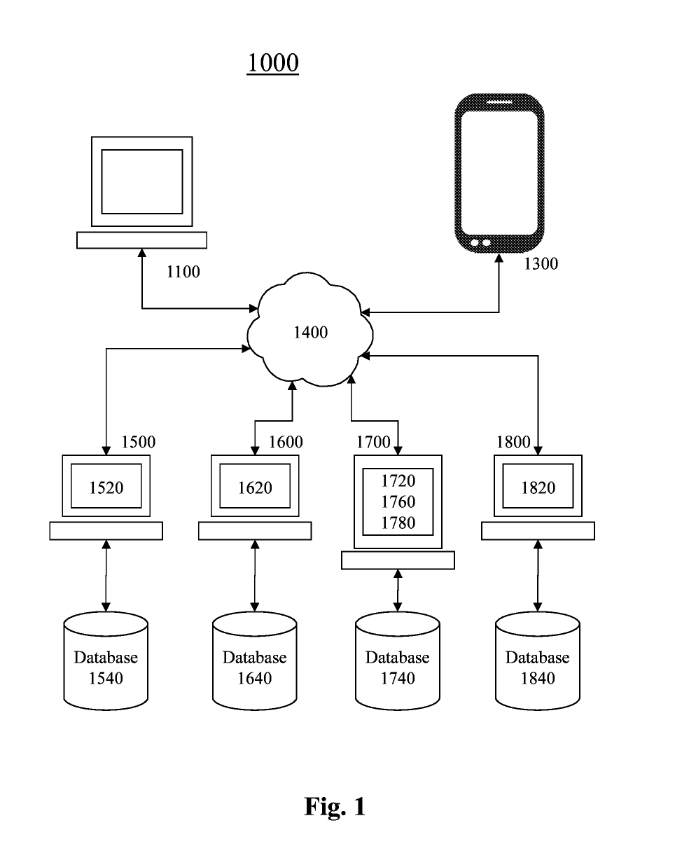

FIG. 1 is a block diagram of an exemplary embodiment of a system 1000, which can comprise a smartphone 1300, an information device 1100, a network 1400, a first server 1500, a second server 1600, a third server 1700, and a fourth server 1800. First server 1500 can comprise a first user interface 1520 and can be coupled to a first database 1540. Second server 1600 can comprise a second user interface 1620 and can be coupled to a second database 1640. Third server 1700 can comprise a third user interface 1720, a processor 1760, machine instructions 1780, and can be coupled to a third database 1740. Fourth server 1800 can comprise a fourth user interface 1820 and can be coupled to a first database 1840. Any of the methods and/or steps thereof can be carried out in whole or in part by smartphone 1300, information device 1100 and/or first server 1500. Second server 1600, third server 1700, and/or fourth server 1800 can each be associated with a financial institution and each can comprise rewards and/or account information concerning financial accounts stored in memory devices coupled thereto. In certain exemplary embodiments, system 1000 can be used to implement one or more methods disclosed herein.

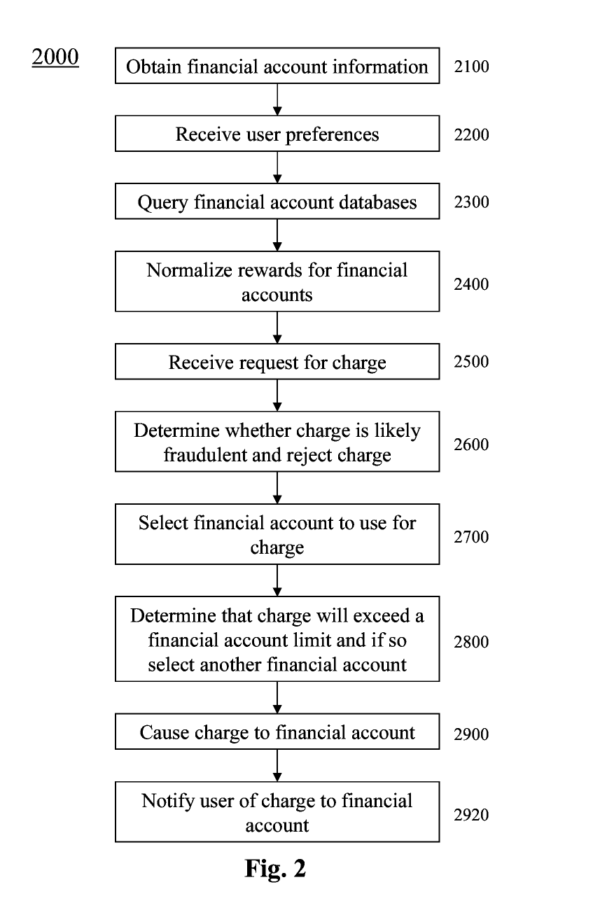

FIG. 2 is a flowchart of an exemplary embodiment of a method 2000. At activity 2100, financial account information can be obtained. For example, the user can provide a plurality of financial accounts to a service such as Apple Pay™ for payment of charges.

At activity 2200, user preferences can be received. For example, the user can be automatically prompted to enter a preference concerning rewards. The preference concerning rewards can be selected from a plurality of preferences. The plurality of preferences can comprise one or more preferences for monetary rewards, points rewards, and/or mileage rewards, etc. In certain exemplary embodiments, the user can provide the preference. The preference received from the user can cause a charge to have a greater rewards program value for a given account than would otherwise be the case in an objective rewards evaluation.

At activity 2300, financial account databases can be automatically queried for financial account information. Account reward information can be obtained via an automatic query of a database comprising the reward information. Each of the plurality of databases can correspond to a separate account of the plurality of financial accounts. Each database can be automatically queried to obtain data concerning rewards. Each of the plurality of databases corresponding to each of the plurality of financial accounts can be automatically queried to obtain credit limit information and/or transaction information for each of the plurality of financial accounts. For example, each of the plurality of databases can be queried for transaction information for a predetermined time period (e.g., three years).

The databases can further be queried to establish reward valuations based upon redemption options. For example, rewards denominated in money can have redemption options, which sometimes be redeemed for cash. In other circumstances, rewards denominated in money can be redeemed for gift certificates that sometimes can be purchased at a discount to face value. In other circumstances, rewards denominated in money can be redeemed for travel benefits, such as airline tickets, train tickets, bus tickets, lodging reservations, and/or dining expenses, etc.

As another example, rewards denominated in points can have redemption options, which sometimes can be redeemed for money. In other circumstances, rewards denominated in points can be redeemed for gift certificates that sometimes can be purchased at a discount to face value. In other circumstances, rewards denominated in points can be redeemed for travel benefits, such as airline tickets, train tickets, bus tickets, lodging reservations, and/or dining expenses, etc.

As another example, rewards denominated in miles can have redemption options, which sometimes can be redeemed for money. In other circumstances, rewards denominated in miles can be redeemed for gift certificates that sometimes can be purchased at a discount to face value. In other circumstances, rewards denominated in miles can be redeemed for travel benefits, such as airline tickets, train tickets, bus tickets, lodging reservations, and/or dining expenses, etc.

In certain exemplary embodiments, each of the plurality of databases can be queried for a transaction and rewards history of the user. The transaction and rewards history information can be analyzed for each account can be analyzed to determine an assumed customer return rate (“ACRR”) for the user. The ACRR can reflect a baseline of rewards utilization by the user without the systems, devices, and/or methods disclosed herein.

At activity 2400, rewards for financial accounts can be automatically normalized. Rewards for the charge for each of the plurality of financial account can be normalized to the common basis. A value of each reward from each of the plurality of financial accounts automatically normalized to a common basis, wherein the common basis is selected based upon a first preference received from a user selected from a plurality of common basis. The plurality of common basis can comprise a monetary valuation, a point valuation and/or a mileage valuation, etc. The user can be automatically prompted to select the common basis.

Once a common basis is selected and/or determined by selection or default, potential rewards for a requested charge can be determined and normalized for each of the plurality of financial accounts. For example, a given financial account provider can be automatically queried for standard and/or special rewards. Standard rewards can be predicated upon a predetermined amount of money, points, or miles per dollar of money expended for a charge. Instead of and/or in addition to standard rewards, financial account providers can offer premiums for certain categories of charges (e.g., higher rewards for gasoline, dining, and/or travel, etc.) and/or certain levels of charges (e.g., a one-time reward for paying a predetermined total amount of charges during a predetermined time period). Certain exemplary embodiments can calculate a normalized value for a reward for the charge for each of the plurality of financial accounts. The normalized value can be based upon awards redemption options and amounts for each account. In certain exemplary embodiments, a weighted average of a value of rewards amounts and/or possible redemption options can be used to calculate the normalized value. For example, some rewards programs allow for a gift certificate purchased at a discount to face value. Such discounted opportunities can be included in the weighted average of the value of rewards amounts. The weighted average can also take into consideration user preferences. For example, if a user prefers gift certificates to cash, the weighted average can change a weight to increase the normalized rewards value to reflect discounts of the gift certificates relative to face value.

By way of one simple example, if a financial account provides for a point for each dollar spent from the financial account, the points have a value of $0.01 per point, gift cards are obtained at a 20% discount relative to face value, and the user indicates a preference solely for gift cards; the normalized value for a $1,000 charge can be determined as: (1,000 dollars*1 point/dollar*$0.01/point*1.20)=$12.00. The normalized value would be increased for any special rewards.

At activity 2500, a request can be received for a charge. In certain exemplary embodiments, a calculation can be made for the charge to determine a return on purchase (“ROP”) or a mean purchase authority (“MPA”) each of which can reflect an amount of a reward for an account selected to yield a highest reward of the plurality of accounts. The ROP and/or the MPA can be compared to the ACRR via a value added calculation (“VAC”) to determine a value to the user of the devices, systems, and/or methods disclosed herein.

Certain exemplary embodiments provide an ability to track the benefits of the devices, systems, and/or methods disclosed herein. For example, the benefits of the improved rewards results can be monitored quarterly and a cumulative quarterly value added credit (“CQVAC”) can be determined.

At activity 2600, a determination can be made as to whether a charge is likely fraudulent and/or the charge can be rejected because it has been determined as likely fraudulent. A charge to a financial account of a plurality of financial accounts can be rejected and/or caused to be automatically rejected based upon a determination that the charge is likely fraudulent. The determination that the charge is likely fraudulent can be based upon querying the plurality of databases. For example, a determination can be made that the charge is likely fraudulent:
if a set of transactions from one or more of the plurality of financial accounts exceeds a predetermined amount during a predetermined time period;
if the nature of the charge is determined to be atypical for the user; and/or
a delivery address for charged goods is different from a billing address for the user; etc.

At activity 2700, a financial account can be selected for use for a charge. The financial account can be automatically selected for the charge based upon a determination that a reward for using the financial account for the charge is more valuable than any other determined reward for using any other of the plurality of financial accounts. The reward information can be determined from the account reward information.

At activity 2800, a determination can be made that a charge will exceed a financial account limit and, if so, another financial account can be selected for the charge. The account from the plurality of accounts can be rejected for the charge because the charge would cause the rejected financial account to be above a credit limit.

At activity 2900, a charge to a financial account can be caused. Certain exemplary embodiments provide, via a signal from an information device, causing a charge to a financial account of a plurality of financial accounts. In certain exemplary embodiments, the charge is processed via a commercial service such as Apple Pay®. In certain exemplary embodiments, the commercial service can collect a premium for selecting the financial account. The premium can be a flat fee per time period (e.g., a predetermined fee per month), a flat per transaction fee (e.g., a predetermined fee per transaction), and/or can be a percentage of the value of the rewards obtained via making the charge to the selected account (e.g., a determined percentage of the VAC for each charge).

At activity 2920, the user of the information device can be automatically notified of the charge to the financial account.

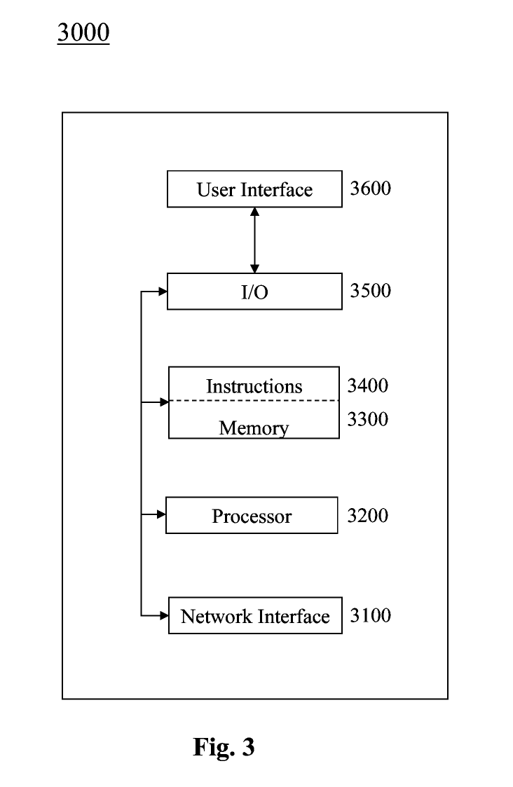

FIG. 3 is a block diagram of an exemplary embodiment of an information device 3000, which in certain operative embodiments can comprise, for example, smartphone 1300, information device 1100, first server 1500, second server 1600, third server 1700, and fourth server 1800 of FIG. 1. Information device 3000 can comprise any of numerous circuits and/or components, such as for example, one or more network interfaces 3100, one or more processors 3200, one or more memories 3300 containing instructions 3400, one or more input/output (I/O) devices 3500, and/or one or more user interfaces 3600 coupled to one or more input/output (I/O) devices 3500, etc.

In certain exemplary embodiments, via one or more user interfaces 3600, such as a graphical user interface, a user can view a rendering of information related to selecting a financial account for a particular transaction based upon an automatic comparison of normalized reward that determines an optimal financial account to pay for a given transaction that provides a highest value reward to a user.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
account reward information—data concerning a premium received for using a financial account for payment of a debt. The reward can comprise monetary rewards, point rewards, and/or mileage rewards, etc.
activity—an action, act, step, and/or process or portion thereof.
and/or—either in conjunction with or in alternative to.
apparatus—an appliance or device for a particular purpose
associate—to join, connect together, and/or relate.
automatically—acting or operating in a manner essentially independent of external influence or control. For example, an automatic light switch can turn on upon “seeing” a person in its view, without the person manually operating the light switch.
based upon—determined in consideration of.
can—is capable of, in at least some embodiments.
cause—to produce an effect.
charge—a payment to satisfy a debt.
circuit—an electrically conductive pathway and/or a communications connection established across two or more switching devices comprised by a network and between corresponding end systems connected to, but not comprised by the network.
common basis—a selected unit basis to which rewards having different unit valuations are converted for value comparison purposes.
comprising—including but not limited to.
concerning—pertaining to.
configure—to make suitable or fit for a specific use or situation.
constructed to—made suitable or fit for a specific use or situation.
convert—to transform, adapt, and/or change.
create—to bring into being.
credit limit—a maximum threshold value for a financial account that a financial institution forbids the exceedance of.
data—distinct pieces of information, usually formatted in a special or predetermined way and/or organized to express concepts.
database—a collection of related data stored on an information device.
data structure—an organization of a collection of data that allows the data to be manipulated effectively and/or a logical relationship among data elements that is designed to support specific data manipulation functions. A data structure can comprise metadata to describe the properties of the data structure. Examples of data structures can include: array, dictionary, graph, hash, heap, linked list, matrix, object, queue, ring, stack, tree, and/or vector.
define—to establish the outline, form, or structure of.
determine—to obtain, calculate, decide, deduce, and/or ascertain.
device—a machine, manufacture, and/or collection thereof.
estimate—to calculate and/or determine approximately and/or tentatively.
financial account—a monetary repository established by contract between a user and a financial institution that provides for funds to be paid from the repository when certain contractual conditions are met.
fraudulent—deceit or trickery perpetrated for profit.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
likely—probable.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine readable medium—a physical structure from which a machine can obtain data and/or information. Examples include a memory, punch cards, etc.
may—is allowed and/or permitted to, in at least some embodiments.
memory device—an apparatus capable of storing analog or digital information, such as instructions and/or data. Examples include a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and/or can store instructions adapted to be executed by processor, such as according to an embodiment disclosed herein.
method—a process, procedure, and/or collection of related activities for accomplishing something.
mileage valuation—a determined rewards amount that is related to travel distances.
monetary valuation—a determined rewards amount that is related to a quantity of currency of a determined denomination.
network—a communicatively coupled plurality of nodes. A network can be and/or utilize any of a wide variety of sub-networks, such as a circuit switched, public-switched, packet switched, data, telephone, telecommunications, video distribution, cable, terrestrial, broadcast, satellite, broadband, corporate, global, national, regional, wide area, backbone, packet-switched TCP/IP, Fast Ethernet, Token Ring, public Internet, private, ATM, multi-domain, and/or multi-zone sub-network, one or more Internet service providers, and/or one or more information devices, such as a switch, router, and/or gateway not directly connected to a local area network, etc.
network interface—any device, system, or subsystem capable of coupling an information device to a network. For example, a network interface can be a telephone, cellular phone, cellular modem, telephone data modem, fax modem, wireless transceiver, ethernet card, cable modem, digital subscriber line interface, bridge, hub, router, or other similar device.
normalize—to convert to a common basis.
notify—to inform via a user interface.
obtain—to acquire pursuant to a request.
plurality—the state of being plural and/or more than one.
point valuation—a determined rewards amount that is related to an abstract quantity of a reward that can be exchanged for something of value.
predetermined—established in advance.
preference—something that is desired more than an alternative.
probability—a quantitative representation of a likelihood of an occurrence.
processor—a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium IV series of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.
project—to calculate, estimate, or predict.
prompt—a message rendered via a user interface to a user requesting information or requesting that an action be performed by a user.
provide—to furnish, supply, give, and/or make available.
query—a request made via an information device for specified data from a database.
receive—to get as a signal, take, acquire, and/or obtain.
recommend—to suggest, praise, commend, and/or endorse.
reject—to refuse to complete a transaction.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
reward—a premium given in return for completing one or more transactions.
select—to make a choice or selection from alternatives.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
transaction—a business deal that proceeds in accordance with a contract.
transmit—to send as a signal, provide, furnish, and/or supply.
use—to employ for some purpose.
user—a person that employs a system.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
valuable—having a monetary worth.
value—relative worth.
via—by way of and/or utilizing.
weight—a value indicative of importance.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
via a signal from an information device, causing a charge to a financial account of a plurality of financial accounts, said financial account automatically selected for said charge based upon a determination that a reward for using said financial account for said charge is more valuable than any other determined reward for using any other of said plurality of financial accounts, said reward determined from account reward information, said account reward information obtained via an automatic query of a database comprising said reward information, a value of each reward from each of said plurality of financial accounts automatically normalized to a common basis, wherein said common basis is selected based upon a first preference received from a user selected from a plurality of common basis, said plurality of common basis comprising a monetary valuation, a point valuation and a mileage valuation, said user automatically prompted to select said common basis.

2. The method of claim 1, further comprising:
automatically prompting said user for a preference concerning rewards, said preference selecting from a plurality of preferences, said plurality of preference comprising monetary rewards, points rewards, and mileage rewards.

3. The method of claim 1, further comprising:
automatically querying databases for each of said plurality of financial accounts to obtain data concerning rewards.

4. The method of claim 1, further comprising:
automatically normalizing rewards for said charge for each of said plurality of financial account to said common basis, said rewards normalized based upon a weighted average of possible redemption options, said weighted average adjustable by said user when said user provides a redemption preference concerning said redemption options.

5. The method of claim 1, further comprising:
automatically notifying said user of said information device of said charge.

6. The method of claim 1, wherein:
said user causes said charge to be more valuable based upon a second preference received from said user.

7. A method comprising:
causing a charge to a financial account of a plurality of financial accounts, said financial account automatically selected for said charge based upon a determination that a reward for using said financial account for said charge is more valuable than any other determined reward for using any other of said plurality of financial accounts, said reward determined from account reward information, said account reward information obtained via an automatic query of a database comprising said reward information, a value of each reward from each of said plurality of financial accounts automatically normalized to a common basis.

8. The method of claim 7, wherein:
said common basis is a monetary valuation.

9. The method of claim 7, wherein:
said common basis is a point valuation.

10. The method of claim 7, wherein:
said common basis is a mileage valuation.

11. The method of claim 7, further comprising:
automatically prompting a user for a preference concerning rewards, said preference selecting from a plurality of preferences, said plurality of preference comprising monetary rewards, points rewards, and mileage rewards.

12. The method of claim 7, further comprising:
automatically querying databases for each of said plurality of financial accounts to obtain data concerning rewards.

13. The method of claim 7, further comprising:
automatically querying databases to obtain credit limit information for each of said plurality of financial accounts.

14. The method of claim 7, further comprising:
automatically querying databases to obtain credit limit information for each of said plurality of financial accounts;
rejecting an account from said plurality of accounts for said charge because said charge would cause said rejected financial account to be above a credit limit.

15. The method of claim 7, further comprising:
automatically querying databases to obtain transaction information for each of said plurality of financial accounts.

16. The method of claim 7, further comprising:
automatically normalizing rewards for said charge for each of said plurality of financial account to said common basis.

17. The method of claim 7, further comprising:
automatically notifying a user of said information device of said charge.

18. The method of claim 7, wherein:
said charge is processed via Apple Pay.

19. The method of claim 7, wherein:
said charge is processed via Apple Pay; and
a premium is collected for selecting said financial account.

20. A method comprising:
causing a charge to a financial account of a plurality of financial accounts to be rejected, said charge automatically rejected based upon a determination that said charge is likely fraudulent, said determination that said charge is likely fraudulent based upon querying a plurality of databases, each of said plurality of databases corresponding to a financial account of a user, each of said plurality of databases further queried for account reward information, a value of each reward from each of said plurality of financial accounts automatically normalized to a common basis.
